(19) United States
(12) Patent Application Publication
(10) Pub. No.: US 2004/0096718 A1
(43) Pub. Date: May 20, 2004

(54) Proton membrane fuel cells

(76) Inventor: Rodolfo Antonio M Gomez, Urrbrae (AU)

Correspondence Address: Klauber & Jackson, Continental Plaza, 411 Hackensack Avenue, Hackensack, NJ, 07601, US

(21) Appl. No.: 10/474,340

(22) PCT Filed: Apr. 9, 2002
(86) PCT No.: PCT/AU02/00444

(30) Foreign Application Priority Data
Apr. 11, 2001 (AU) PR 4351

(51) Int. Cl. H01M 8/10; H01M 4/86; H01M 4/96; H01M 4/92

(52) U.S. Cl. 429/30; 429/40; 429/32; 429/44; 429/13

(57) ABSTRACT

A process and apparatus to modify the conventional proton exchange membrane fuel cell by applying a proton exchange semiconductor membrane that allows electrons to migrate from the catholde to the anode and cylindrical-conical fuel cell elements that allow internally stacking the fuel cell elements by a simple method. These modifications in the operating principle and construction configuration of the proton exchange membrane fuel cell are designed to result in a major increase in the power density output necessary for transport vehicle and stationary power generation applications.

### FIELD OF INVENTION

This invention relates to a modified operating principle, construction and configuration of fuel cells and a method of internal stacking of the fuel cell elements to produce higher power density to make fuel cells suitable for use in transport vehicles and for small to large stationary electric power generation units.

The invention will be particularly discussed with reference to the proton membrane fuel cell using hydrogen fuel but is also applicable to other fuels and to other types of fuel cells such as solid oxide fuel cells.

### PRIOR ART

Fuel cells under development during the last four decades include the phosphoric acid fuel cell, the proton electrolytic membrane fuel cell, the molten carbonate fuel cell, and the solid oxide fuel cell. While phosphoric add fuel cells up to 250 kilowatts capacity are commercially available, the most advanced fuel cell is the proton electrolytic membrane fuel cell, however, its further commercial application is limited by the low power density of current designs and reported highest power capacity for transport vehicles and stationary power generation units is about 300 kilowatts.

This invention consists of modifying the operating principle, the construction of the proton electrolytic membrane fuel cell, and a method of internal stacking of the fuel cell elements to increase the power density of the fuel cell group so that it is suitable for application to transport vehicles and small and large stationary power generation. The objective is about 85 to 120 kilowatts for small transport vehicles and 300 to 400 kilowatts for large transport vehicles. In stationary power generation, the objective is to provide 3 to 5 kilowatts for home use, 250 kilowatts and 1,000 kilowatts for dispersed community power requirements, and 10,000 to 500,000 kilowatts for centralized power generation.

### Construction of Proton Electrolytic Membrane Fuel Cells and Other Fuel Cells

Most proton electrolytic membrane fuel cells are planar in construction such as the Ballard Power fuel cell where the fuel cell elements have been “stacked” in a neat cubical configuration. Passageways are provided for the supply of hydrogen and oxygen and the removal of the reaction products. The disadvantage of this construction is that pressure on the hydrogen side is limited as high pressure may cause rupture and seal failure allowing the hydrogen to mix directly with the oxygen with catastrophic results.

A cylindrical cell construction would offer the possibility of higher pressure differential between the hydrogen side and the oxygen side. Several U.S. patents have been granted for proton electrolytic membrane fuel cells that are cylindrical in shape such as:

U.S. Pat. No. 5,458,989 (Oct. 17, 1995)—Tubular fuel cells with structural current collectors—Dodge, C. et al,

U.S. Pat. No. 5,509,942 (Apr. 23, 1996)—Manufacture of tubular fuel cells with structural current collectors—Dodge C. et al,

U.S. Pat. No. 6,001,500 (Dec. 14, 1999)—Cylindrical proton exchange membrane fuel cells and methods of making same—Bass E. et al,

U.S. Pat. No. 6,007,932 (Dec. 28, 1999)—Tubular fuel cell assembly and method of manufacture—Steyn W. et al,

U.S. Pat. No. 6,060,188 (May 9, 2000)—High pressure coaxial fuel cell—Muthuswamy S. et al, and

U.S. Pat. No. 6,063,517 (May 16, 2000)—Spiral wrapped cylindrical proton exchange membrane fuel cells and method of making same—Montemayor A. et al.

The proton electrolytic membrane fuel cells above describe several cylindrical configurations of the proton electrolytic membrane fuel cell. A major shortcoming of the above construction is how to maintain good contact between the proton exchange membrane and the anode and cathode electrodes under all operating conditions of the proton electrolytic membrane fuel cell, particularly under varying temperatures. Loosening of the contact between the membrane and the electrodes would increase the impedance of the proton electrolytic membrane fuel cell and even cause the proton electrolytic membrane fuel cell to cease functioning.

U.S. Pat. No. 5,244,752 (Sep. 14, 1993)—Apparatus tube configuration and mounting for solid oxide fuel cell—Zymboly, G. concerns a tubular configuration for a solid oxide fuel cell.

It is an objective of this invention to overcome one or more of the above problems.

### BRIEF DESCRIPTION OF THE INVENTION

In one form therefore the invention is said to reside in a proton exchange membrane fuel cell including an anode and a cathode separated by a proton exchange membrane characterised by the proton exchange member comprising a semiconductor adapted to allow transfer of electrons from the cathode to the anode.

Preferably the anode has a catalytic surface adapted to catalyse hydrogen to hydrogen ions. The anode catalytic surface may be fine platinum or compounds of metals. For other types of fuel cells alternative catalysts may be used.

Similarly the cathode may have a catalytic surface selected from the group comprising platinum and nickel or compounds of metals.

In an alternative form the invention may be said to reside in a fuel cell having an anode cell and an anode at one wall thereof, a cathode cell and a cathode at one wall thereof and a proton exchange membrane between the anode cell and the cathode cell and engaged against the anode and the cathode characterised by the proton exchange membrane being a semiconductor and adapted to allow transfer of electrons from the cathode to the anode.

In one embodiment the proton exchange membrane is homogeneous and hence is formed from a material which will conduct electrons in one direction and will allow the passage of protons in the opposite direction.

Alternatively the proton exchange membrane is segmented and comprises a first portion which is non-electrically conductive and which allows protons to move from the anode electrode to the cathode electrode and a second which portion which is semiconductive and allows transfer of electrons from the cathode electrode to the anode electrode.

Preferably the anode surface within the anode cell has a catalytic surface adapted to catalyse hydrogen to hydrogen ions. The anode catalytic surface may be fine platinum or compounds of metals.

Preferably the cathode surface with the cathode cell has a catalytic surface selected from the group comprising platinum and nickel or compounds of metals.

Both the cathode and anode may be formed from material which allows easy passage of hydrogen ions which may be selected from the group carbon or metal hydrides.

Alternatively the cathode and the anode are formed from a material which allows easy passage of hydrogen and the anode has a catalytic surface engaged against the proton exchange membrane.

In an alternative form the invention may be said to reside in a fuel cell including an anode having an angled face, a cathode having a complimentary angled face and a proton exchange membrane between the angled face of the anode and the complimentary angled face of the cathode and a force means to draw the angled faces together with the proton membrane engaged therebetween.

Preferably the anode electrode is cylindrical and the angled face is an internal frusto-conical surface and the cathode electrode is cylindrical and the complimentary angled surface is an external frusto-conical surface and the force means causes engagement of the internal frustoconical surface and the external frustoconical surface with the proton exchange membrane sandwiched therebetween.

Preferably the proton exchange membrane is a semiconductor adapted to allow transfer of electrons from the cathode electrode to the anode electrode.

The proton exchange membrane may be selected from a group comprising a polymer, a rubber or a ceramic each of which is doped to make it semiconductive. The dopant may be silicon or other material that preferably allow electrons to move in one direction only.

Instead of a homogenous material, the proton exchange membrane may also be constructed in discrete segments where one segment may be a proton exchange membrane that allows the hydrogen proton to pass readily from the anode electrode to the cathode electrode but not electrons, and the next segment connected to the first segment may be a material that is a semiconductor that allows the flow of electrons from the cathode electrode to the anode electrode. There may be several segments in this type of proton exchange membrane. The net effect of this segmental construction is that protons are allowed to travel from the anode electrode to the cathode electrode while electrons are allowed to travel only from the cathode electrode to the anode electrode.

The operating principle of a fuel cell based on a complete electronic circuit of this invention may also be used to improve the power output of other types of fuel cells such as the planar or tubular solid oxide fuel cell or ceramic cell. The solid electrolyte that allows the movement of the oxygen ion is further doped to allow the travel of electrons in one direction only providing a complete electronic circuit. As in proton membrane fuel cells, the solid electrolyte may be homogenous or constructed in segments connected to each other, one segment allowing the movement of the oxygen ion and the adjacent segment allowing the movement of electrons in one direction only.

The surface of each of the anode and cathode not being the angled faces may have an increased surface area by means including grooving, pyramiding or roughening of the surface.

The anode and the cathode may be formed from material permeable to protons being selected from a group comprising carbon or metal hydrides and the active surfaces of each of the anode and cathode include a catalyst which may be fine platinum or nickel.

Alternatively the cathode and the anode are formed from a material which allows easy passage of hydrogen and the anode has a catalytic surface engaged against the proton exchange membrane.

Alternatively the cathode and anode catalyst may be formed from compounds that catalyze the oxidant and the fuel.

In an alternative form the invention may be said to reside in a process to produce electricity from the reaction of hydrogen and oxygen to produce water, the process including the steps of:

a) pressurising hydrogen at the outer catalyst surface of an outer cylindrical anode electrode;

b) catalysing the hydrogen to hydrogen ions and electrons wherein the electrons travel in an external electrical circuit through an electrical load to an inner cylindrical cathode and the hydrogen ions travel through the anode, a proton exchange semi-conductor membrane between the anode and the cathode and the cathode to an inner catalytic surface of the cathode; and

c) reacting the hydrogen ions with oxygen at the catalytic surface of the cathode to produce water,

wherein the proton exchange membrane is a semiconductor adapted to allow transfer of electrons from the cathode to the anode.

In this process the anode electrode may have a cylindrical shape outside and a slightly conical shape inside and the cathode electrode may have a cylindrical shape inside and a slightly conical shape outside complementary to the conical shape of the anode.

An alternative construction is the anode may be a cubical shape outside and a slighting trapezoidal shape inside and the cathode electrode may be cubical inside with slightly trapezoidal shape outside matching the inside anode trapezoidal shape with the proton membrane sandwiched between the anode and cathode electrodes.

There may be further included means to apply a force to draw the anode and cathode together to engage the proton exchange membrane therebetween.

The hydrogen may be at a pressure of up to 333 bars and the oxygen may be provided at a pressure up to 10 bars at the cathode and the process may be operated at a temperature of up to 250° C.

In an alternative form the invention may be said to reside in a fuel cell assembly formed from a stack of a plurality of fuel cells as described above.

The fuel cells may be electrically connected in series or in parallel.

The fuel cell assembly may include annular non-conducting seals between the fuel cells with the seals incorporating electrical connections between the adjacent fuel cells.

The stack of fuel cells may be within a cylindrical container to allow hydrogen to be pressurised on the outer side of the anode cells and oxygen or air is passed through the inside of the fuel cells.

There may be included means to provide good contact between the oxygen or air and the cathode surface such as a helical baffle.

The fuel cell stack may include force application means on the stack of fuel cells to promote sealing at each of the annular seals and to promoting engagement of the respective anodes and cathodes to the proton exchange membrane therebetween.

In an alternative form the invention may be said to reside in a process of producing electricity from the reaction of hydrogen and oxygen to produce water, the process including the steps of providing a stack of fuel cells and operating them as described above.

In an alternative form the invention is said to reside in a proton exchange membrane fuel cell including an anode electrode and a cathode electrode characterized by;

a proton exchange semiconductor membrane that allows movement of the hydrogen ion from the anode electrode to the cathode electrode and electrons from the cathode electrode to the anode electrode; and

the anode electrode having a frusto-conical surface on the inner surface and the cathode electrode with a frusto-conical outer surface matching the frusto-conical inner surface of the anode electrode and the proton exchange semiconductor membrane held between the anode electrode and cathode electrode.

Alternatively, the invention is said to reside in a proton exchange fuel cell arrangement comprising a plurality of fuel cell elements, each fuel cell element having an anode electrode and a cathode electrode and characterised by;

a proton exchange semiconductor membrane that allows movement of the hydrogen ion from the anode electrode to the cathode electrode and electrons from the cathode electrode to the anode electrode;

the anode electrode having a frusto-conical surface on the inner surface and the cathode electrode with a frusto-conical outer surface matching the frusto-conical inner surface of the anode electrode and the proton exchange semiconductor membrane held between the anode electrode and cathode electrode; and

the fuel cells having a simple internal stacking of the fuel cell elements in a cylindrical cell container to allow high pressure hydrogen operation of the fuel cell arrangement.

The operating principle of this proton exchange fuel cell with the homogenous or segmented membrane providing a complete electronic circuit for the fuel cell may be applied to other types of fuel cells with solid electrolyte such as the solid oxide fuel cell to improve the power output.

### BRIEF DESCRIPTION OF THE DRAWINGS

This then generally describes the invention but to assist with understanding of the invention reference will now be made to the accompanying drawings which show preferred embodiments of the invention.

In the drawings:

FIG. 1A shows a schematic view of a proton exchange membrane fuel cell with a homogenous membrane according to the invention;

FIG. 1B shows a schematic view of a proton exchange membrane fuel cell with a segmented membrane according to the invention;

FIG. 2 shows a cross section of an embodiment of a fuel cell according to this invention;

FIG. 3 shows a cross section of a stack of fuel cells of the type shown in FIG. 2;

FIG. 4 shows a cross section of an alternative embodiment of a stacked fuel cell;

FIGS. 5A and 5B show a still further embodiment of a fuel cell stack; and

FIGS. 6A, 6B and 6C show an alternative construction of a fuel cell with increased surface area.

### DETAILED DESCRIPTION OF THE PREFERRED EMBODIMENTS

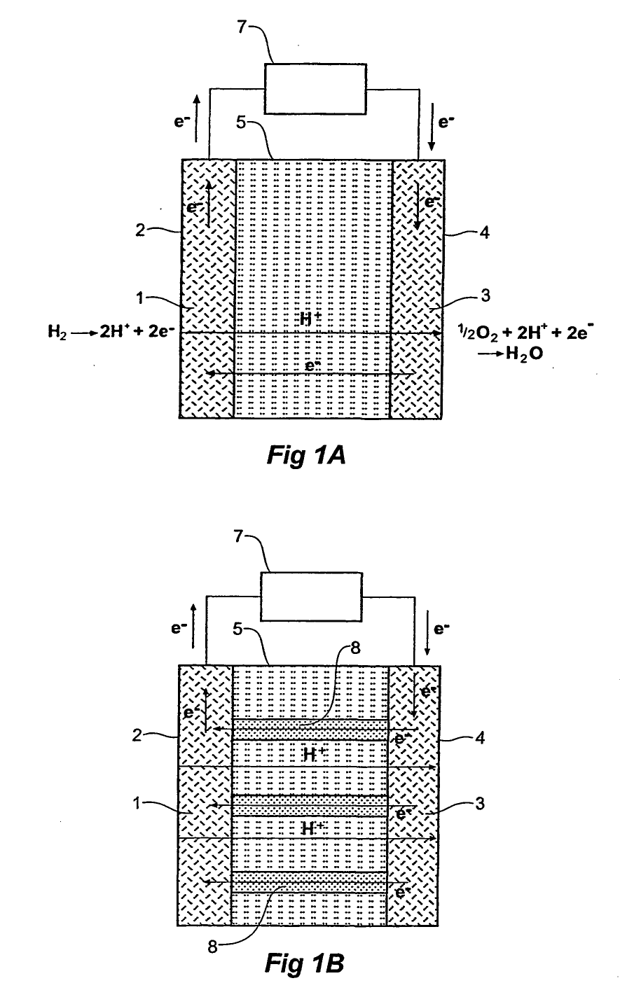

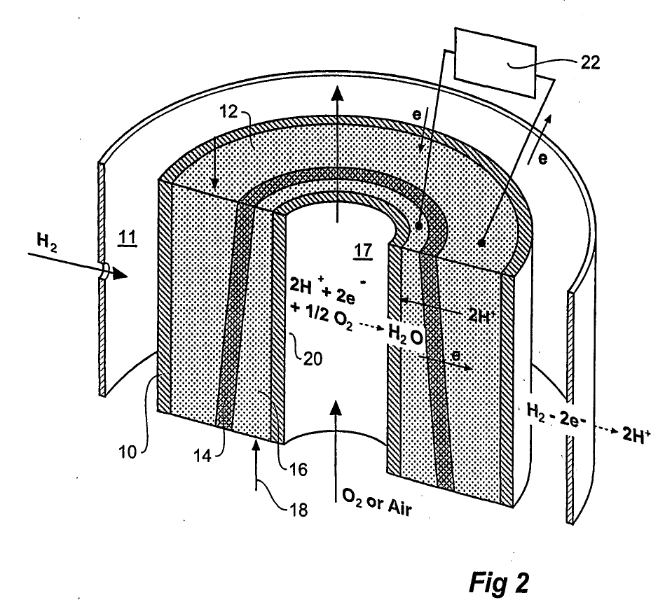

The operating principle of the proton electrolytic membrane fuel cell modified according to the present invention is shown on FIG. 1A with a homogenous membrane and 1B with a segmented membrane. Referring to FIG. 1A, the fuel cell has and anode 1 and a cathode 3 separated by a homogenous proton exchange membrane 5 wherein the proton exchange membrane is also a semiconductor adopted to allow transfer of electrons from the cathode to the anode instead of being a non-conductor as in the prior art. Each of the anode 1 and the cathode 3 have a catalytic surface 2 and 4 respectively. The catalytic reaction at the anode converts the hydrogen to hydrogen ions or protons and these are allowed to travel from the anode through the proton exchange semiconductor membrane 5 to the cathode while electrons produced are allowed to travel to the external load 7 then to the cathode and then through the proton exchange semiconductor membrane to the anode. This provides a complete electronic circuit.

FIG. 1B shows a fuel cell of the invention where the membrane is made of segments. Proton exchange non-conductor membrane segment 6 allows the hydrogen proton to travel from the anode to the cathode while semiconductor membrane segment 8 allows the electrons to travel from the cathode to the anode. Segments 6 and 8 may or may not be connected to each other and may be shaped planar, conical, or trapezoidal similar to the shape of the homogenous proton exchange semiconductor membrane.

Hydrogen is provided at the anode and is catalysed in the following reaction:

H₂→2H⁺+2e⁻

At the cathode oxygen is supplied and the reaction is catalysed as follows:

½O₂+2H⁺+2e⁻→H₂O

The proton exchange semiconductor membrane that allows the hydrogen proton to pass from the anode to the cathode and electrons to travel from the cathode to the anode may be constructed of a homogenous doped polymer or doped rubber or ceramic material or the proton exchange membrane may be constructed of connected segments, one segment allowing the hydrogen proton to pass from the anode to the cathode and the adjacent segments allowing the electrons to travel from the cathode to the anode. It must be sufficiently pliable so that it will conform to the conical or trapezoidal surfaces of the anode electrode and the cathode electrode it is in contact with. Further, the membrane must be stable at the operating temperature and pressure of the fuel cell.

A further aspect of the invention relates to a cubical-trapezoidal configuration of the fuel cell but preferably a cylindrical-conical configuration of the fuel cell. Axial opposing forces may be applied to a fuel cell with such a configuration forcing the cathode electrode against the anode electrode with the proton electrolytic membrane sandwiched between. This will allow good contact to be maintained between the membrane and the anode and cathode electrodes for a proper operation of the fuel cell under all operating conditions.

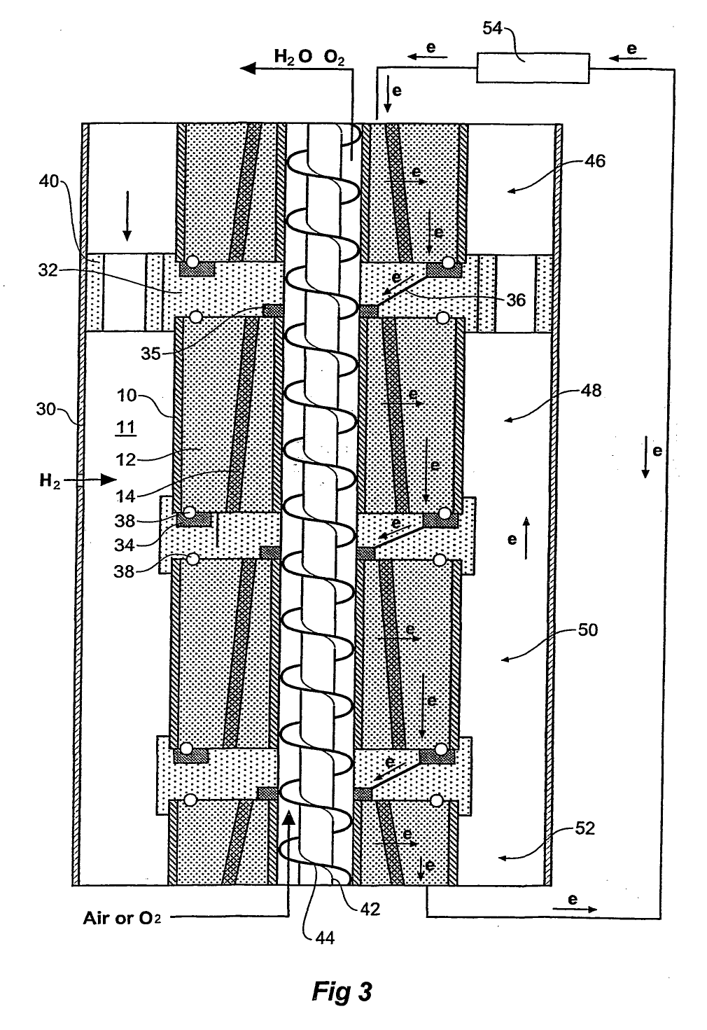

FIG. 2 shows the preferred construction of one embodiment of a cell element of the cylindrical-conical fuel cell.

In this embodiment the anode catalyst 10 is located outside of the anode electrode 12 in a cylindrical anode cell 11. Where the hydrogen fuel has impurities such as carbon oxides, the anode catalyst may be located in the inside of the anode electrode. As shown in FIG. 2, the cylindrical anode electrode 12 with the anode catalyst 10 located on the outer surface is slightly conical on the inside. The proton electrolytic membrane 14 which is semi-conductive is also slightly conical and fits into the inside of the anode electrode 12. The outer surface of the cylindrical cathode electrode 16 is slightly conical and fits into the cone of the proton electrolytic membrane 14 and the inside cone of the anode electrode 12. The cathode electrode 16 is pushed axially upward 18 while the anode electrode is restrained so that there is a force causing the inside of the anode electrode 12 to maintain contact with the outside of the cathode electrode 16 with the proton electrolytic membrane 14 sandwiched in-between. The material of the anode and cathode electrode is electrically conducting and needs to allow easy passage of the hydrogen ion and must have structural strength to withstand the high pressure differential between the hydrogen in the anode cell 11 and the air or oxygen in the cathode cell 17 at the operating temperature of the fuel cell.

The inner surface of the cathode electrode 16 has a catalyst 20 on it.

The anode and cathode electrodes are made of electrically conducting material such as metals, alloys, hydrides and carbon that allows easy passage of the hydrogen ion through the crystal lattice or grain boundaries of the material. There are many such materials known due to the extensive research into the use of these materials for the storage of hydrogen.

In operation, the hydrogen atom is catalyzed to hydrogen ion by the anode catalyst at the anode electrode. The electrons travel to the external circuit via the electrical load 22 and return to the cathode electrode. The hydrogen ion travels to the cathode catalyst 20 located at the inner surface of the cathode electrode 16 where the hydrogen ion reacts with the oxygen and the electrons from the external electrical circuit to form water. The electronic circuit is completed by the passage of electrons from the cathode electrode through the semi-conductor membrane 14 to the anode electrode.

A simple model to explain the operating principle of the fuel cell is that there is a continuous flow of electrons in the electronic circuit. At the anode, electrons from the oxidation of the hydrogen join this electronic circuit. The hydrogen ion travels to the cathode. At the cathode, some electrons are used by the cathode reaction to carry out the reaction forming water from the hydrogen ions and the oxygen available at the catalyst surface of the cathode electrode.

The cylindrical-conical construction allows a large pressure differential between the anode (hydrogen) and the cathode (oxygen). This creates a stronger driving force for the diffusion of the hydrogen ion due to the substantially higher concentration of hydrogen ions at the anode electrode. This will result in a higher current density for the fuel cell even without considering the higher power density of the fuel cell as a result of the complete electronic circuit provided by the proton exchange semiconductor membrane.

It is projected that the fuel cell according to the invention can operate at hydrogen pressures of up to 333 bars and up to 10 bars of air or oxygen pressure. The higher the operating temperature, the higher the diffusion rate of the hydrogen ion through the anode and cathode electrodes. The normal operating temperature of the fuel cell may range from 25° C. up to 250° C. or more. The operating temperature will be limited mainly by the materials of construction of the fuel cell.

Fuel cells can produce high currents but the voltage of each cell is theoretically 1.229 volts for the hydrogen-oxygen fuel cell and is usually lower under load in an operating system. It is desirable to connect the cells in series or “stack” these to produce a high working voltage.

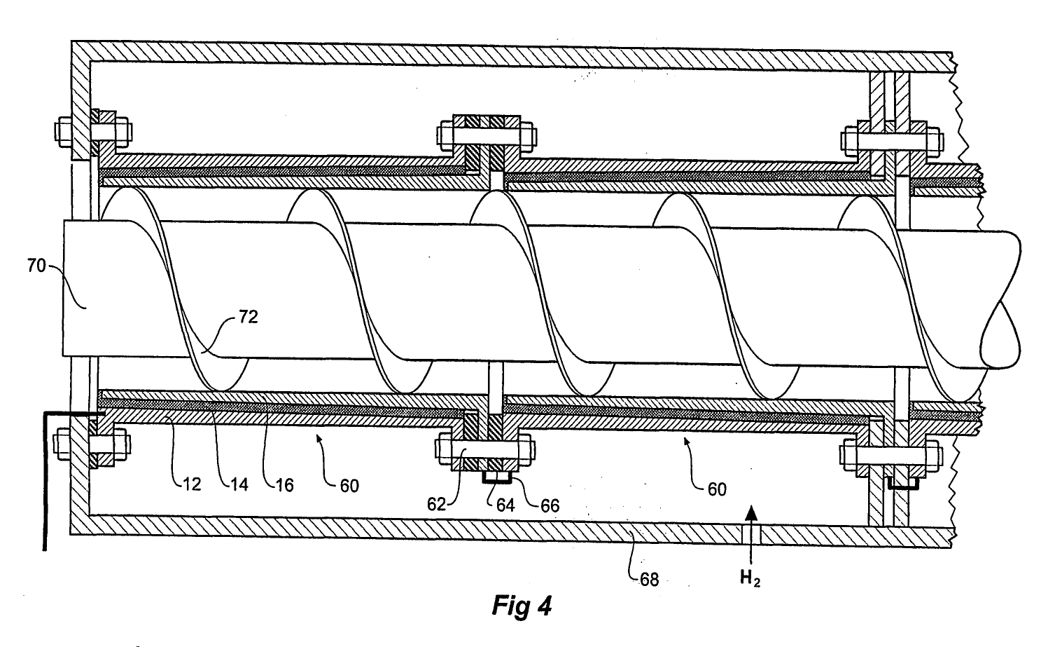

In the third aspect of this invention, the fuel cell elements may be stacked internally as shown in one alternate in FIG. 3. Each cell is the same as that shown in FIG. 2 and the same reference numerals are used for the same components.

The cell elements are held in a tube 30 pressurized with hydrogen. Each cell element is electrically isolated by a non-conducting annular ring 32 that is made of a plastic or ceramic material. An outer annular conducting ring 34 in contact with the anode electrode and an inner annular conducting ring 35 in contact with the cathode electrode are imbedded in the non-conducting ring. These two rings are connected by a conductor wire 36 imbedded in the non-conducting annular ring 32. Sealing O-rings 38 or similar are installed between the anode electrode 12 and the non-conducting annular ring 32 to separate the hydrogen from the oxygen. The dimension and compressibility of the inner and outer conducting rings and the O-ring seals selected so that when a compressive force is applied to the fuel cell elements, the anode electrodes are forced against the annular ring 32 to seal against it and at the same time achieve sealing of the hydrogen from the air or oxygen and the conical surfaces of the anode and cathode electrodes forced against each other to hold the proton membrane in good contact.

Larger diameter non-conducting rings 40 with holes are installed at appropriate intervals to center the fuel cell elements within the cylindrical container 30. An inner cylinder 42 with continuous helical vane or baffle 44 is installed in the cathode cell cavity to ensure good contact of the air or oxygen with the cathode catalyst and to effect the efficient removal of the fuel cell reaction product.

The electronic circuit is described as follows. Starting from cell element 46, electrons travel from the cathode electrode to the anode electrode to the outer conducting ring through the imbedded wire conductor to the inner conducting ring of cell element 48 to the cathode electrode of cell element 48 to the anode electrode of cell element 48 to the outer conducting ring through the imbedded wire conductor to the inner conducting ring of cell element 50 to the cathode electrode of cell element 50 to the anode electrode to the outer conducting ring through the imbedded wire conductor to the inner conducting ring of cell element 52 to the cathode electrode of cell element 52 to the anode electrode of cell element 52 to the external conductor to the electrical load 54 and to the cathode electrode of cell element 46.

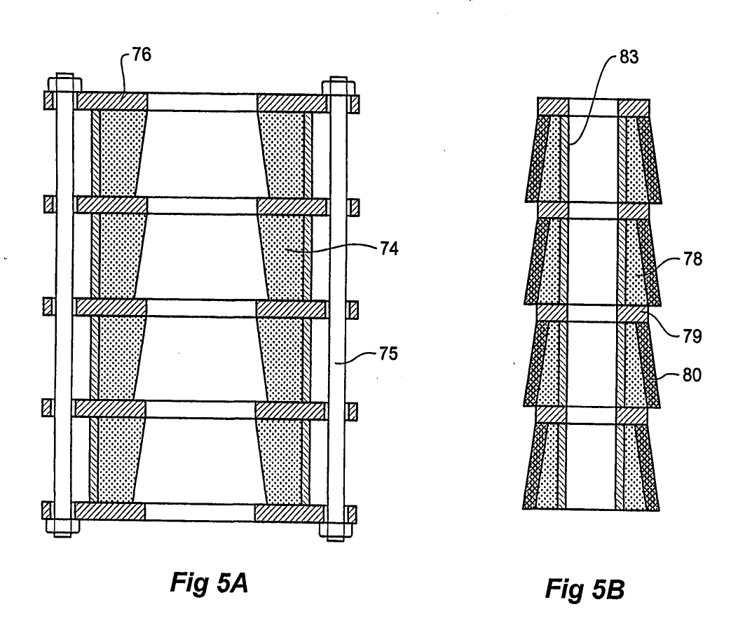

Another method of internal stacking is shown on FIG. 4. Each cell is the same as that shown in FIG. 2 and the same reference numerals are used for the same components. In this method, instead of opposing forces achieving contact between the membrane and the electrodes, each fuel cell element is bolted to the next fuel cell element to achieve the force to keep the membrane in contact with the electrodes.

The device consists of a plurality of fuel cells 60 each composed of an anode 12 and a cathode 16 separated by a semiconductive proton exchange membrane 14. Each cell is connected to adjacent cells by insulated bolts 62 and compressible seals 64 are filled between the cells and electrical connection 66 is provided between the cathode of one cell and the anode of the next.

The entire stack is received in a cylindrical tank 68 so that hydrogen can be pressurised around the anodes of the cells. The cylindrical inner surfaces of the cathodes are exposed to air or oxygen and a central cylinder 70 with helical baffles 72 ensures good contact of the air with the catalytic surface 20 of the cathode 16.

In the device shown in FIG. 4, the dimension and compression characteristics of the seals 64 are important to achieve the seal between the hydrogen and the oxygen and the force required to maintain contact between the anode electrode 12 the membrane 14 and the cathode electrode 16.

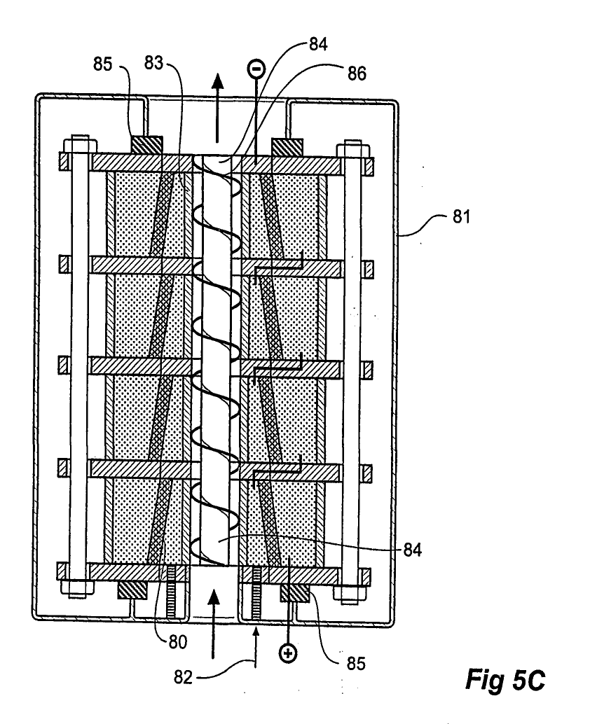

Another method of internal stacking the fuel cells is shown in FIG. 5.

The anode stack, FIG. 5A, is a set of anode electrodes 74 held together by at least three long bolts 75 through non-conductor annular rings 76. The anode non-conducting annular rings 76 incorporate the necessary electrical connections and the seals to maintain the pressure differential between the hydrogen side and the oxygen side and are grooved to center the cylindrical-conical anode electrodes.

The cathode stack, FIG. 5B, is a set of cathode electrodes 78 which are separated by non-conducting annular rings 79 incorporating electrical connections and grooves to centre the cylindrical-conical cathode electrodes.

The assembly, FIG. 5C, shows the anode electrode stack installed inside a cylindrical container 81 with seals 85 to contain the hydrogen at the anode side. The cathode electrode stack with matching conical dimensions are installed inside the anode electrode stack with the semiconductive proton exchange membrane 80 sandwiched between the anode electrodes and the cathode electrodes. A force 82 is applied at bottom end of the cathode electrode stack so that the cathode electrodes 78 are firmly in contact with the membrane 80 and the anode electrodes 74. An inner cylinder 84 with helix 86 is installed through the cathode electrode 78 stack to ensure good contact of the air or oxygen with the catalyst 83 of the cathode electrodes 78.

Heat is produced during the fuel cell reaction. Part of this heat is used for pre-heating the hydrogen and the oxygen or oxygen-nitrogen feed to the fuel cell. Excess heat from the fuel cell may be used for external application such as domestic or industrial heating or water desalination.

It is desirable to have the largest specific surface of the electrodes to achieve the highest possible power density for a given volume of the fuel cell. The active surfaces of the anode and cathode electrodes may be grooved or of pyramidal structure to give a high specific surface area of the catalysts.

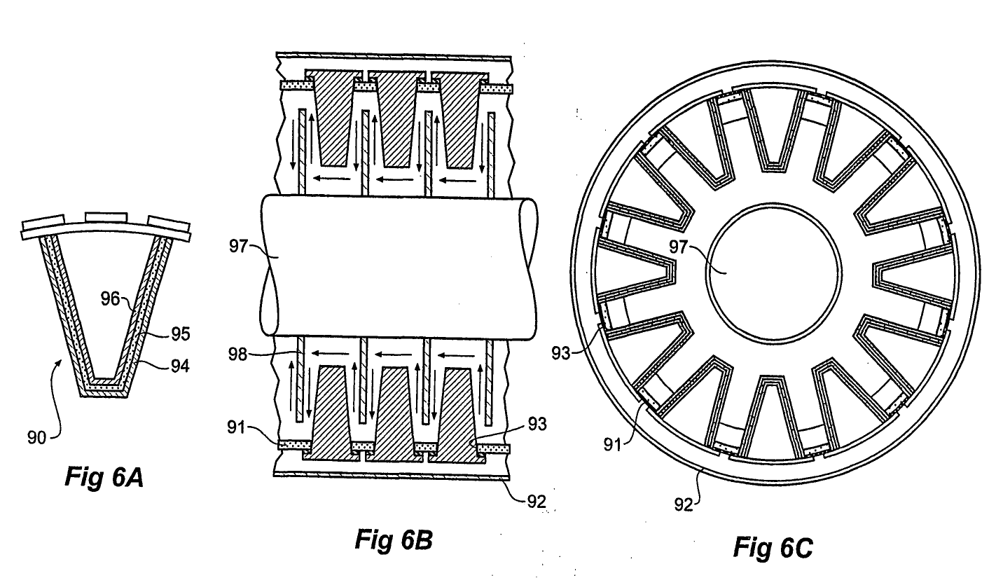

Another method is to increase the total surface area of the electrodes for a given volume of the fuel cell as shown in an example in FIG. 6.

FIG. 6A shows an individual fuel cell element, FIG. 6B shows a cross section of the assembly and FIG. 6C shows a plan view of the assembly.

V-shaped fuel cell elements 90 are installed in a non-conducting frame 91 located inside a cylinder 92.

The frame 91 is cylindrical with rectangular apertures 93 to receive each of the fuel cells 90. Each fuel cell 90 is made up of a cathode 94, a proton exchange semiconductor membrane 95 and a cathode electrode 96. Suitable sealing is provided around each cell.

The fuel cell elements are held in place by two conducting straps, one for connecting the anode electrodes and the other strap connecting the cathode electrodes. A cylinder 97 with circular baffles 98 is installed inside the non-conducting frame.

Hydrogen is pressurized between the cylinder container 92 and the non-conducting frame 91 while air or oxygen is passed between the inner cylinder 97 and the non-conducting frame 91. The circular baffles 98 of the inner cylinder ensure good contact between the air and the cathode catalyst and the efficient removal of the reaction product. A construction of the fuel cell as shown in FIG. 6C would provide a substantially higher power density per unit volume of the fuel cell.

In the cell stacking alternatives described above, there may be as many cell elements in a fuel cell stack as required to produce the desired working voltage. For instance, there may be about 12 cell elements in the stack to produce 12 volts or 120 cell elements in the stack to produce 120 volts. There may be two 12 cell stacks and these may be connected in series to produce 24 volts or a higher current output at 12 volts if the 12 cell stacks are connected in parallel. There may be several fuel cell stacks inside a cell container.

Aside from the current density and electrical efficiency achieved in the fuel cell, the dimensions of the fuel cell element and the number of fuel cell elements in a stack determine the power output. Table 1 shows a projection of the dimensions of the fuel cell from 3 kilowatts up to 50,000 kilowatts. The highest reported power density in conventional proton exchange membrane fuel cell is Ballard Power with a power density of 1.3 kilowatts per liter that is equivalent to about 1.3 amperes per square centimeter. In Table 1, the assumption is 3.0 amperes per square centimeter and the electrical efficiency is 73.2 percent. Table 1 shows that the fuel cell dimensions and the number of stacks are practical and achievable for commercial application.

TABLE 1
Fuel Cell Size for Commercial Plants
Assumptions:

| Fuel Cells are cylindro-conical in shape with diameter approximately equal to the height. | |
|---|---|
| Current Density, amperes per square centimeter | 3 |
| Theoretical Cell Voltage, volts | 1.229 |
| Ratio of Cell Voltage at Load | 0.732 |

Note: The ratio of Cell Voltage at Load is equivalent to the Electrical Efficiency.

Projections:

| | Voltage | | | | | | | | | | |
|---|---|---|---|---|---|---|---|---|---|---|---|
| | Required | | | | | | | | | | |
| Fuel Cell | in | Cells | | Total | Area of | Nominal | Nominal | Selected | Selected | Height of | Final Fuel |
| Output | Stack, | in the | Number | Current | Each Cell | Cell Dia. | Cell Height | Diameter | Height | Stack plus | Cell Output |
| Kilowatts | Volts | Stack | of Stacks | Amperes | cm2 | cm | Cm | cm | cm | 20%, cm | Kilowatts |
| 3 | 20 | 22 | 2 | 75 | 25 | 2.8 | 2.82 | 2.7 | 3 | 80 | 3.05 |
| 3 | 12 | 13 | 2 | 125 | 42 | 3.6 | 3.64 | 4 | 3.4 | 54 | 3.08 |
| 5 | 20 | 22 | 1 | 250 | 83 | 5.2 | 5.15 | 5 | 5.4 | 144 | 5.09 |
| 5 | 12 | 13 | 2 | 208 | 69 | 4.7 | 4.70 | 5 | 5 | 80 | 5.65 |
| 50 | 20 | 22 | 6 | 417 | 139 | 6.6 | 6.65 | 7 | 7 | 187 | 55.42 |
| 75 | 12 | 13 | 8 | 781 | 260 | 9.1 | 9.10 | 10 | 8.3 | 133 | 75.10 |
| 100 | 80 | 89 | 2 | 625 | 208 | 8.1 | 8.14 | 8.2 | 8.2 | 875 | 101.40 |
| 250 | 80 | 89 | 5 | 625 | 208 | 8.1 | 8.14 | 8.2 | 8.2 | 875 | 253.49 |
| 1000 | 80 | 89 | 14 | 893 | 298 | 9.7 | 9.73 | 10 | 10 | 1067 | 1055.58 |
| 10000 | 80 | 89 | 20 | 6250 | 2083 | 25.8 | 25.75 | 26 | 26 | 2773 | 10193.86 |
| 50000 | 80 | 89 | 40 | 15625 | 5208 | 40.7 | 40.72 | 50 | 33.5 | 3573 | 50516.93 |

Throughout this specification various indications have been given as to the scope of this invention but the invention is not limited to any one of these but may reside in two or more of these combined together. The examples are given for illustration only and not for limitation.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The claims defining the invention are as follows:

1. A proton exchange membrane fuel cell including an anode electrode and a cathode electrode characterized by;
a proton exchange semiconductor membrane that allows movement of the hydrogen ion from the anode electrode to the cathode electrode and electrons from the cathode electrode to the anode electrode; and
the anode electrode having a frusto-conical surface on the inner surface and the cathode electrode with a frusto-conical outer surface matching the frusto-conical inner surface of the anode electrode and the proton exchange semiconductor membrane held between the anode electrode and cathode electrode.

2. A proton exchange fuel cell arrangement comprising a plurality of fuel cell elements, each fuel cell element having an anode electrode and a cathode electrode and characterised by;
a proton exchange semiconductor membrane that allows movement of the hydrogen ion from the anode electrode to the cathode electrode and electrons from the cathode electrode to the anode electrode;
the anode electrode having a frusto-conical surface on the inner surface and the cathode electrode with a frusto-conical outer surface matching the frusto-conical inner surface of the anode electrode and the proton exchange semiconductor membrane held between the anode electrode and cathode electrode; and
the fuel cells having a simple internal stacking of the fuel cell elements in a cylindrical cell container to allow high pressure hydrogen operation of the fuel cell arrangement.

3. A proton exchange membrane fuel cell including an anode and a cathode separated by a proton exchange membrane characterised by the proton exchange member comprising a semiconductor adapted to allow transfer of electrons from the cathode electrode to the anode electrode and protons from the anode electrode to the cathode electrode.

4. A fuel cell as in claim 3 wherein the proton exchange membrane is homogeneous.

5. A fuel cell as in claim 3 wherein the proton exchange membrane is segmented and comprises a first portion which is non-electrically conductive and which allows protons to move from the anode electrode to the cathode electrode and a second which portion which is semiconductive and allows transfer of electrons from the cathode electrode to the anode electrode.

6. A fuel cell as in claim 3 wherein the anode has a catalytic surface adapted to catalyse hydrogen to hydrogen ions.

7. A fuel cell as in claim 3 wherein the anode catalytic surface is fine platinum.

8. A fuel cell as in claim 3 wherein the cathode has a catalytic surface.

9. A fuel cell as in claim 8 wherein the cathode catalytic surface is selected from the group comprising platinum and nickel.

10. A fuel cell having an anode cell and an anode at one wall thereof, a cathode cell and a cathode at one wall thereof and a proton exchange membrane between the anode cell and the cathode cell and engaged against the anode and the cathode characterised by the proton exchange membrane being a semiconductor and adapted to allow transfer of electrons from the cathode electrode to the anode electrode.

11. A fuel cell as in claim 3 wherein the proton exchange membrane is homogeneous.

12. A fuel cell as in claim 11 wherein the proton exchange membrane is segmented and comprises a first portion which is non-electrically conductive and which allows protons to move from the anode electrode to the cathode electrode and a second which portion which is semiconductive and allows transfer of electrons from the cathode electrode to the anode electrode.

13. A fuel cell as in claim 10 wherein the anode surface within the anode cell has a catalytic surface adapted to catalyse hydrogen to hydrogen ions.

14. A fuel cell as in claim 10 wherein the anode catalytic surface is fine platinum.

15. A fuel cell as in claim 10 wherein the cathode surface with the cathode cell has a catalytic surface selected from the group comprising platinum and nickel.

16. A fuel cell as in claim 10 wherein the cathode and anode are formed from material which allows easy passage of hydrogen ions.

17. A fuel cell as in claim 15 wherein the cathode and anode are formed from a material selected from the group carbon or metal hydrides.

18. A fuel cell as in claim 10 wherein the cathode and the anode are formed from a material which allows easy passage of hydrogen and the anode has a catalytic surface engaged against the proton exchange membrane.

19. A fuel cell including an anode having an angled face, a cathode having a complimentary angled face and a proton exchange membrane between the angled face of the anode and the complimentary angled face of the cathode and force means to draw the angled faces together with the proton exchange engaged therebetween.

20. A fuel cell as in claim 19 wherein the cathode is cylindrical and the angled face is an internal frusto-conical surface and the cathode is cylindrical and the complimentary angled surface is an external frusto-conical surface and the force means causes engagement of the internal frustoconical surface and the external frustoconical surface with the proton exchange membrane sandwiched therebetween.

21. A fuel cell as in claim 19 or claim 16 (20?) wherein the proton exchange membrane is a semiconductor adapted to allow transfer of electrons to the cathode to the anode.

22. A fuel cell as in claim 21 wherein the proton exchange membrane is selected from a group comprising a polymer, a rubber or a ceramic each of which is doped to make it semiconductive.

23. A fuel cell as in claim 22 wherein the dopant is silicon.

24. A fuel cell as in claim 19 wherein a surface of each of the anode and cathode not being the angled faces has an increased surface area by means including grooving, pyramiding or roughening of the surface.

25. A fuel cell as in claim 19 wherein the anode and the cathode are formed from material permeable to protons being selected from a group comprising carbon or metal hydrides.

26. A fuel cell as in claim 19 wherein the active surfaces of each of the anode and cathode include a catalyst.

27. A fuel cell as in claim 26 wherein the catalyst is fine platinum.

28. A fuel cell as in claim 19 wherein the cathode and the anode are formed from a material which allows easy passage of hydrogen and the anode has a catalytic surface engaged against the proton exchange membrane.

29. A process to produce electricity from the reaction of hydrogen and oxygen to produce water, the process including the steps of:
d) pressurising hydrogen at the outer catalyst surface of an outer cylindrical anode electrode;
e) catalysing the hydrogen to hydrogen ions and electrons wherein the electrons travel from the anode electrode to an external electrical circuit through an electrical load to an inner cylindrical cathode through a proton exchange semiconductor membrane to the anode electrode and the hydrogen ions travel through the anode, the proton exchange semiconductor membrane between the anode and the cathode and the cathode to an inner catalytic surface of the cathode; and
f) reacting the hydrogen ions with oxygen at the inner catalytic surface of the cathode to produce water,
wherein the proton exchange membrane of homogenous or segmented construction and is a semiconductor adapted to allow transfer of electrons from the cathode to the anode.

30. A process as in claim 29 wherein the anode electrode has a cylindrical shape outside and a slightly conical shape inside.

31. A process as in claim 29 wherein the cathode electrode has a cylindrical shape inside and a slightly conical shape outside complementary to the conical shape of the anode.

32. A process as in claim 29 further including means to apply a force to draw the anode and cathode together to engage the proton exchange membrane therebetween.

33. A process as in claim 29 wherein the hydrogen is at a pressure of up to 333 bars.

34. A process as in claim 29 wherein the oxygen is provided at a pressure up to 10 bars at the cathode.

35. A process as in claim 29 operated at a temperature of up to 250° C.

36. A process as in claim 29 wherein the cathode and the anode are each formed from a material which allows the passage of protons and are formed from a material selected from carbon and metal hydrides.

37. A process as in claim 29 wherein the catalytic surface of the anode and the cathode are each platinum.

38. A process as in claim 29 wherein the anode is permeable to hydrogen and the catalytic surface of the anode is the angled face engaged against the proton exchange membrane whereby impurities in the hydrogen do not poison the catalytic surface.

39. A fuel cell assembly formed from a stack of a plurality of fuel cells as in claim 10.

40. A fuel cell assembly as in claim 39 wherein the fuel cells are electrically connected in series.

41. A fuel cell assembly as in claim 39 wherein the fuel cells are electrically connected in parallel.

42. A fuel cell assembly as in claim 39 including annular non-conducting seals between the fuel cells, the seals incorporating electrical connections between the adjacent fuel cells.

43. A fuel cell assembly as in claim 39 wherein the stack of fuel cells is within a cylindrical container to allow hydrogen to be pressurised on the outer side of the anode cells.

44. A fuel cell assembly as in claim 39 wherein the oxygen or air is passed through the inside of the fuel cells.

45. A fuel cell assembly as in claim 39 including means to provide good contact between the oxygen or air and the cathode surface.

46. A fuel cell assembly as in claim 39 including force application means on the stack of fuel cells to promote sealing at each of the annular seals and to promoting engagement of the respective anodes and cathodes to the proton exchange membrane therebetween.

47. A process of producing electricity from the reaction of hydrogen and oxygen to produce water, the process including the steps of providing a stack of fuel cells and operating the stack of fuel cells according to the process as defined in claim 39.

48. A process as in claim 47 wherein the fuel cells are electrically connected in series.

49. A process as in claim 47 wherein the fuel cells are electrically connected in parallel.

50. A process as in claim 47 wherein hydrogen at a pressure of up to 333 bars is applied to the anode.

51. A process as in claim 47 wherein oxygen at a pressure of up to 10 bars is applied to the cathode.

52. A process as in claim 47 wherein fuel cell stack is operated at a temperature of up to 250° C.
